(19) United States
(12) Patent Application Publication
(10) Pub. No.: US 2024/0185369 A1
(43) Pub. Date: Jun. 6, 2024

(54) BIASING MACHINE LEARNING MODEL OUTPUTS

(71) Applicant: Capital One Services, LLC, McLean, VA (US)

(72) Inventors: Galen RAFFERTY, Mahomet, IL (US); Samuel SHARPE, Cambridge, MA (US); Brian BARR, Schenectady, NY (US); Jeremy GOODSITT, Champaign, IL (US); Austin WALTERS, Savoy, IL (US); Kenny BEAN, Herndon, VA (US)

(21) Appl. No.: 18/061,703

(22) Filed: Dec. 5, 2022

(51) Int. Cl. G06Q 50/18; G06N 20/00

(52) U.S. Cl. CPC G06Q 50/182; G06N 20/00; G06Q 2220/00

(57) ABSTRACT

In some implementations, a device may obtain data indicating reparations issued to a user by one or more entities. The device may determine, using at least one machine learning model, an output in connection with the user. The at least one machine learning model may be trained to determine the output based on the data, and the at least one machine learning model may be trained to determine the output with a bias based on a probability, indicated by the data, of the user obtaining reparations for the output being erroneous. The device may transmit, to a user device, information based on the output.

### BACKGROUND

Artificial intelligence describes different ways that a machine interacts with an environment. Through advanced, human-like intelligence (e.g., provided by software and hardware), an artificial intelligence system may perceive an environment and take actions that maximize a chance of achieving goals. Machine learning is an approach, or a subset, of artificial intelligence, with an emphasis on learning rather than just computer programming. A machine learning system may utilize complex models to analyze a massive amount of data, recognize patterns among the data, and generate an output (e.g., a prediction, a classification, or the like) without requiring a human to program specific instructions.

### SUMMARY

In some implementations, a system for biasing machine learning model outputs includes one or more memories, and one or more processors communicatively coupled to the one or more memories. The one or more processors may be configured to determine, using a first machine learning model, a probability of a user obtaining reparations for an automated output being erroneous. The first machine learning model may be trained to determine the probability of the user obtaining reparations based on data indicating reparations issued to the user by one or more entities. The one or more processors may be configured to determine, using a second machine learning model, an output in connection with the user. The second machine learning model may be trained to determine the output with a bias that is based on the probability of the user obtaining reparations. The one or more processors may be configured to transmit, to a user device, information based on the output.

In some implementations, a method of biasing machine learning model outputs includes obtaining, by a device, data indicating reparations issued to a user by one or more entities. The method may include determining, by the device and using at least one machine learning model, an output in connection with the user. The at least one machine learning model may be trained to determine the output based on the data. The at least one machine learning model may be trained to determine the output with a bias based on a probability, indicated by the data, of the user obtaining reparations for the output being erroneous. The method may include transmitting, by the device and to a user device, information based on the output.

In some implementations, a non-transitory computer-readable medium storing a set of instructions for biasing machine learning model outputs includes one or more instructions that, when executed by one or more processors of a device, cause the device to obtain data indicating reparations issued to a user by one or more entities. The one or more instructions, when executed by the one or more processors, may cause the device to determine, using a first machine learning model, an output in connection with the user. The one or more instructions, when executed by the one or more processors, may cause the device to determine, using a second machine learning model, an adjusted output in connection with the user. The second machine learning model may be trained to determine the adjusted output by biasing the output based on a probability of the user obtaining reparations for the output being erroneous. The probability of the user obtaining reparations may be based on the data. The one or more instructions, when executed by the one or more processors, may cause the device to transmit, to a user device, information based on the adjusted output.

### BRIEF DESCRIPTION OF THE DRAWINGS

FIGS. 1A-1C are diagrams of an example associated with biasing machine learning model outputs, in accordance with some embodiments of the present disclosure.

FIG. 2 is a diagram illustrating an example of a blockchain and use thereof, in accordance with some embodiments of the present disclosure.

FIG. 3 is a diagram illustrating an example of training and using a machine learning model in connection with biasing machine learning model outputs, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with biasing machine learning model outputs, in accordance with some embodiments of the present disclosure.

FIG. 6 is a flowchart of an example process associated with biasing machine learning model outputs, in accordance with some embodiments of the present disclosure.

### DETAILED DESCRIPTION

The following detailed description of example implementations refers to the accompanying drawings. The same reference numbers in different drawings may identify the same or similar elements.

Implementations described herein provide a machine learning system that may bias outputs to achieve improved accuracy, thereby efficiently allocating and utilizing computing resources that may have otherwise been expended to reach an erroneous output and/or to perform an automated action based on the erroneous output. For example, various systems may employ artificial intelligence (AI) in reaching decisions (e.g., recommendations, classifications, predictions, or the like) for users. For example, a system may use AI to determine a recommendation for a user, to perform facial recognition of a user, to determine an action for an autonomous vehicle of a user, or to determine whether to approve a user's application for a credit card or loan, among numerous other examples. Sometimes, a decision reached using AI may be erroneous (e.g., the decision may be different from a decision that would be reached by a human that is neutral and fully informed), which may be because the programming for the AI has flawed algorithms and/or because information relating to a user and/or an environment, that is used by the AI to reach a decision, is lacking or misleading. In such cases, a system of reparations (which may be referred to as “digital reparations”) may include recording complaints of erroneous AI decisions and/or recording adjudications of the complaints as records on a blockchain.

Users may frequently seek reparations for erroneous AI decisions if characteristics of the users (e.g., locations of the users, ages of the users, occupations of the users, or the like), or a lack of information about the users, causes the users to be regularly mischaracterized by AI algorithms. An erroneous decision may refer to a recommendation, a classification, a prediction, a clustering, or the like, output by a machine learning model in response to an input that is different from a recommendation, a classification, a prediction, a clustering, or the like, that would have been reached by a human (e.g., the human to which the output is applicable, a domain expert, or the like) using the same input. Thus, systems using AI may allocate and expend significant computing resources (e.g., processor resources, memory resources, or the like) toward reaching erroneous decisions for such users and/or toward performing automated actions based on the erroneous decisions. Moreover, entities associated with the systems may consume additional computing resources in connection with receiving complaints of erroneous AI decisions, investigating erroneous AI decisions, performing remedial actions for erroneous AI decisions, or the like. In some cases, the entities may attempt to identify a cause of the erroneous AI decisions. However, AI decision-making may commonly use a “black box” approach, where an input to, and an output from, an AI system are known, but the logic used by the system to achieve the output may be unknown. Accordingly, significant computing resources may be expended in an attempt to understand or reverse engineer the logic used by the AI systems.

Some implementations described herein may enable a device to bias an output of a machine learning model in connection with a user based on a probability of the user obtaining reparations if the output were to be erroneous. Biasing the output may include changing an output that would have otherwise been provided to a different output. For example, if the device determines a high probability of the user obtaining reparations (e.g., because an AI system is more likely to mischaracterize the user, such as due to the AI system lacking information relating to the user), then the device may bias the output to be more favorable to the user. In one example, biasing the output may include changing an output rejecting an application for services, that would have otherwise been provided, to an output approving the application for services. In another example, biasing the output may include changing an output of a user-specific price for an item or a service, that would have otherwise been provided, to an output of a lower user-specific price for the item or the service.

In some implementations, based on biasing the output to be more favorable to the user, the device may transmit information indicating the biased output to a user device of the user, may perform one or more actions based on the biased output (e.g., cause creation of an account for the user, transfer funds to an account of the user, or the like), and/or may transmit information (e.g., to devices of one or more entities) to indicate whether machine learning model outputs for the user should be biased and/or a type of machine learning model outputs (e.g., credit decisions) that should be biased for the user.

In this way, the device may avoid the output being erroneous, which may have otherwise occurred if the output were not biased, thereby improving the accuracy of the output of the machine learning model. Accordingly, the device may efficiently allocate and utilize computing resources that may have otherwise been expended to reach an erroneous output and/or to perform an automated action based on the erroneous output. Moreover, the device may conserve, or enable another device to conserve, computing resources that may have otherwise been expended in connection with receiving a complaint of an erroneous AI decision, investigating the erroneous AI decision, performing remedial actions for the erroneous AI decision, or the like. In addition, computing resources that may have otherwise been used attempting to understand or reverse engineer the logic used by the AI in reaching the decision may be conserved.

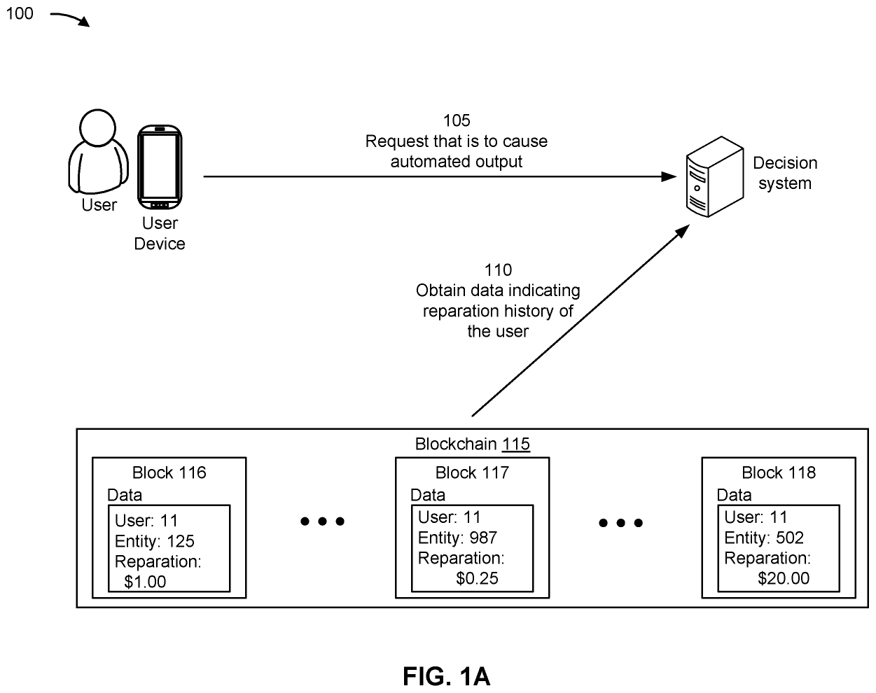

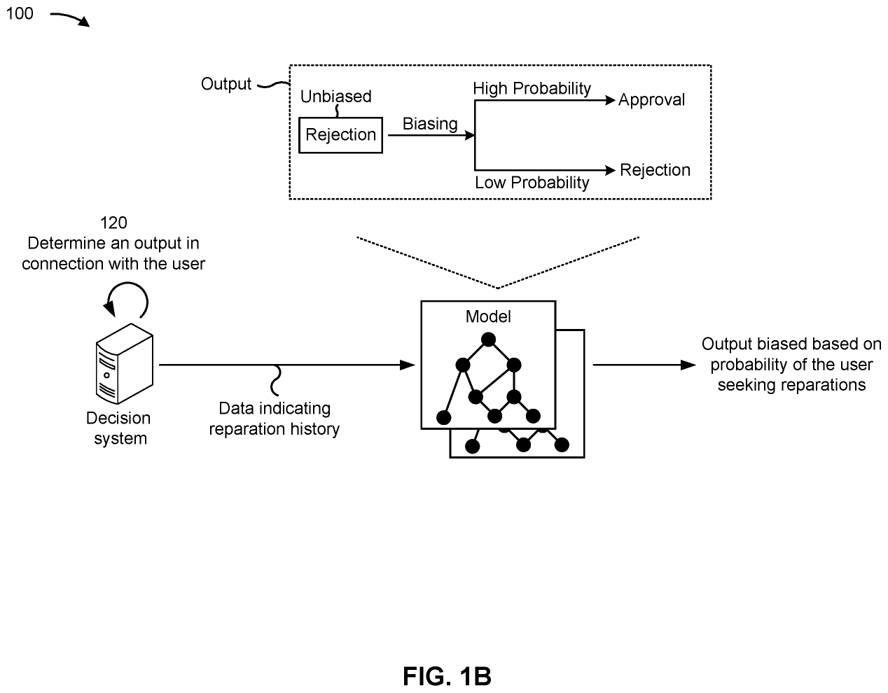

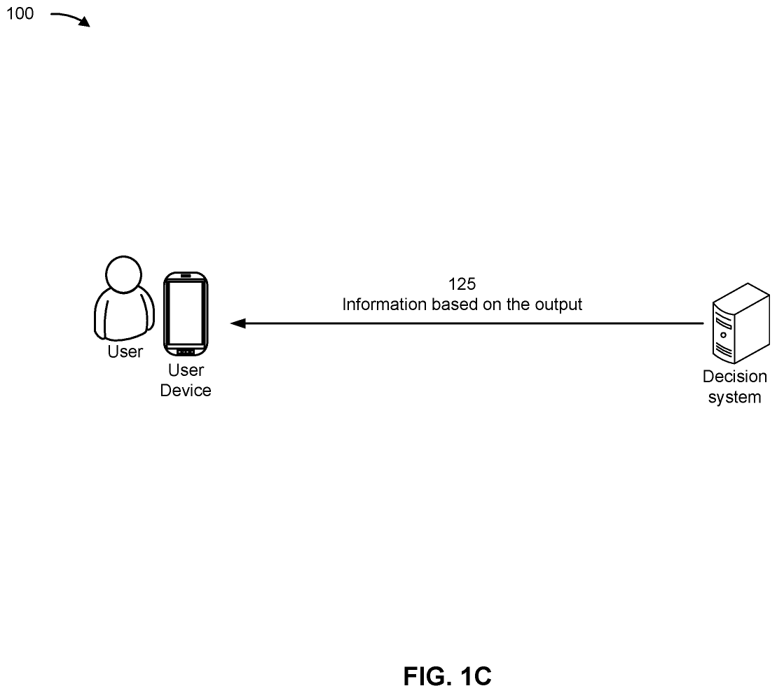

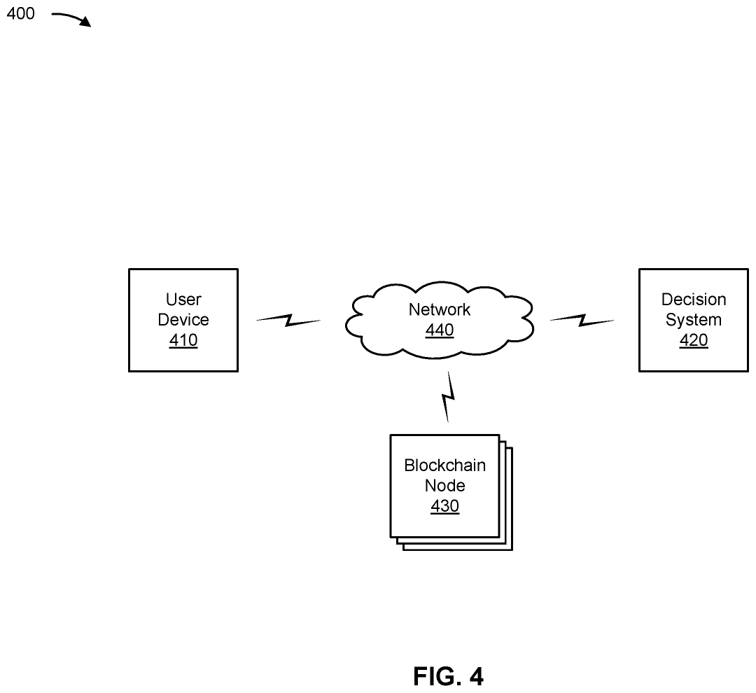

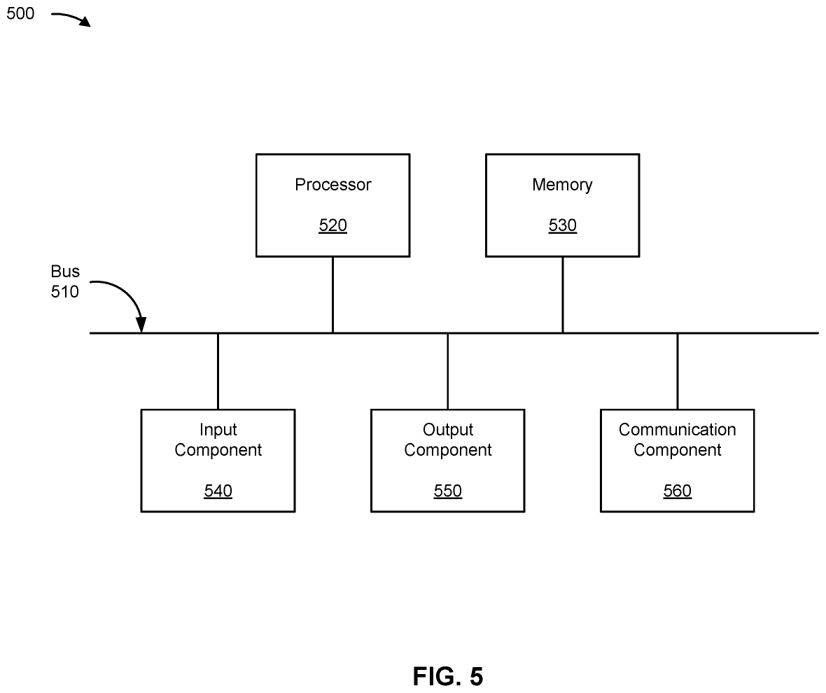

FIGS. 1A-1C are diagrams of an example 100 associated with biasing machine learning model outputs. As shown in FIGS. 1A-1C, example 100 includes a user device and a decision system. These devices are described in more detail in connection with FIGS. 4 and 5.

In some implementations, the user device may be associated with a user that may encounter the use of AI by an entity in reaching a decision for the user. For example, the user may encounter the use of AI in connection with an application for services. As an example, the user may apply for services, such as loan services, line of credit services, and/or mortgage services, among other examples, from the entity. In other examples, the user may encounter the use of AI in connection with a recommendation of an item, a recommendation of an action based on facial recognition, a user-specific price for an item or a service, or the like.

In some implementations, the decision system may be associated with the entity, and the decision system may be configured to use AI in reaching a decision for the user. For example, the decision system may use AI (e.g., a machine learning model) to determine whether to approve or reject the application for services. In other examples, the decision system may use AI to determine the recommendation of the item, determine the recommendation of the action, determine the user-specific price, or the like.

As shown by reference number 105, the user device may transmit, and the decision system may receive, a request that is to cause an automated output. For example, the request may indicate the user's application for services. As another example, the request may be a request to access a resource (e.g., a request to access a webpage that includes recommendations for the user), a request to perform facial recognition, a request for a user-specific price for goods or services, a request for traveling directions, or the like. In other words, the request may cause the decision system to reach a decision, using AI, in connection with the user.

In some implementations, the decision system may identify that an AI technique is to be used to determine the output in connection with the user. For example, the decision system may identify that one or more machine learning models are to be used to determine the output in connection with the user. The decision system may identify that AI (e.g., machine learning model(s)) is to be used to determine the output based on receiving the request. Additionally, or alternatively, the decision system may identify that AI (e.g., machine learning model(s)) is to be used to determine the output based on a resource or system that the user device is accessing. This use of AI by the decision system in reaching the decision may not be apparent to the user.

As shown by reference number 110, before determining the decision in connection with the user, the decision system may obtain data indicating one or more reparations issued to the user by one or more entities (e.g., the reparations were adjudicated for the user and/or the reparations were transferred to the user, for example, devices of the entities may cause the transferring of funds to the user's account). For example, the reparations may have been issued to the user as compensation for one or more erroneous automated outputs (e.g., erroneous AI decisions) reached by the entities in connection with the user. In some implementations, the user (e.g., using the user device) may have registered one or more complaints against the entities for erroneous automated outputs, and adjudication of the complaints (e.g., by a neutral third party) may have resulted in one or more awards of reparations to the user. In some implementations, the data obtained by the decision system may further indicate one or more complaints made by the user indicating that an automated output is erroneous.

The data indicating the reparations and/or the complaints may be in blockchain 115 (e.g., the decision system may obtain the data from blockchain 115 via one or more blockchain nodes, as described herein). For example, blockchain 115 may include complaint information for complaints of erroneous AI decisions in connection with the user or other users and/or the entity or other entities, and/or judgment information indicating adjudications of the complaints. The complaint information, for a complaint of the user, may indicate that a decision, reached using AI, is being contested (e.g., that the decision is believed to be erroneous). The complaint information may identify the user, an entity that made the decision using AI, a use case associated with the use of AI, a time/date associated with the use of AI, a result of the use of AI (e.g., the decision in connection with the user), and/or a non-erroneous result (e.g., a non-erroneous decision) that the use of AI should have reached, among other examples. The judgment information, for a judgment made with respect to a complaint of the user, may identify complaint information for the complaint (e.g., by a complaint identifier), whether a reparation is being awarded, and/or an amount of the reparation, among other examples. As shown, blocks 116, 117, and 118 of blockchain 115 may include judgment information associated with the user (identified in blockchain 115 as user 11). Relative to another data structure, blockchain 115 may provide improved security and reliability of the complaint information and/or the judgment information, thereby enabling the decision system to determine outputs efficiently and accurately.

As shown in FIG. 1B, and by reference number 120, the decision system may determine the output in connection with the user. In other words, the decision system may reach a decision in connection with the user. The decision system may determine the output using at least one machine learning model.

The machine learning model(s) may be trained to determine the output based on the data indicating the reparations and/or the complaints. For example, the machine learning model(s) may be trained to determine the output with a bias that is based on the probability of the user obtaining reparations (e.g., seeking reparations and/or being issued reparations) if the output were to be erroneous, which may be indicated by the data. That is, the output of the machine learning model(s) may be different from another output of one or more other machine learning models that do not bias the output. For example, the output of the machine learning model(s) may be more favorable to the user if the probability of the user obtaining reparations is high (whereas the output of the other machine learning model(s) may be independent of the probability of the user obtaining reparations). In some implementations, the machine learning model(s) may be trained to determine the output further based on a use case associated with the machine learning model(s). The use case may be a particular scenario in which AI was used, such as a scenario involving approving or rejecting an application for services, a scenario involving a recommendation of an item, a scenario involving a recommendation of an action based on facial recognition, a scenario involving determining a user-specific price for an item or a service, or the like.

In some implementations, the output may be a first output if the probability is a first probability, and the output may be a second output if the probability is a second probability. For example, the machine learning model(s) may determine the output biased in favor of the user if the probability is a first probability (e.g., a high probability), and determine the output unbiased if the probability is a second probability (e.g., a low probability). Additionally, or alternatively, a degree by which the output is biased may increase (or decrease) with the probability of the user obtaining reparations. In other words, the higher the probability of the user obtaining reparations, the greater the degree by which the output may be biased. In one example, biasing the output may include changing an output of a user-specific price for an item or a service, that would have otherwise been provided, to an output of a lower user-specific price for the item or the service. Here, for example, if the probability is in a first range (e.g., 90%-100%) the user-specific price may be lowered by a first amount or percentage (e.g., 75%), if the probability is in a second range (e.g., 80%-89%) the user-specific price may be lowered by a second amount or percentage (e.g., 65%), and so forth.

In some implementations, biasing of the output may also, or alternatively, be based on an expected value of reparations obtained by the user. For example, in addition to or alternatively to determining the probability of the user obtaining reparations, the machine learning model(s) may determine an expected value of the reparations that would be obtained. In some implementations, the output may be a first output if the expected value is a first value, and the output may be a second output if the expected value is a second value. For example, the machine learning model(s) may determine the output biased in favor of the user if the expected value is a first value (e.g., a high value), and determine the output unbiased if the expected value is a second value (e.g., a low value). Additionally, or alternatively, a degree by which the output is biased may increase (or decrease) with the expected value of the reparations. In other words, the higher the expected value of the reparations, the greater the degree by which the output may be biased. In one example, biasing the output may include changing an output of a user-specific price for an item or a service, that would have otherwise been provided, to an output of a lower user-specific price for the item or the service. Here, for example, if the expected value is in a first range (e.g., greater than $100) the user-specific price may be lowered by a first amount or percentage (e.g., 75%), if the probability is in a second range (e.g., between $80-$99) the user-specific price may be lowered by a second amount or percentage (e.g., 65%), and so forth.

The machine learning model(s) may be based on an artificial neural network technique (e.g., a deep neural network technique). In some implementations, the machine learning models used to determine the output may include a first machine learning model and a second machine learning model.

In some implementations, the decision system may determine, using the first machine learning model, the probability of the user obtaining reparations if the output of the second machine learning model were to be erroneous. For example, the first machine learning model may be trained to determine the probability (e.g., a percentage, a score, a classification, or the like, that indicates the probability) based on the data indicating the reparations and/or the complaints. As an example, if the data indicates that the user frequently seeks reparations and is awarded reparations (e.g., because an AI system is likely to mischaracterize the user, such as due to the AI system lacking information relating to the user), then the first machine learning model may determine that the probability of the user obtaining reparations is high. For example, the output of the second machine learning model may be a user-specific price, and the data may indicate that the user frequently seeks reparations and is awarded reparations (e.g., in connection with user-specific prices being offered to the user). In some implementations, the first machine learning model may be trained to determine the probability further based on a use case associated with the second machine learning model (e.g., a use case of user-specific pricing), as described herein. For example, one or more first reparations indicated by the data that are related to the use case may be more relevant for determining the probability than one or more second reparations indicated by the data that are not related to the use case. In some implementations, the decision system may determine the probability of the user obtaining reparations using the first machine learning model based on identifying that the second machine learning model is to be used to determine the output in connection with the user.

The decision system may provide information indicating the probability determined by the first machine learning model as an input to the second machine learning model. In some implementations, the decision system may determine, using the second machine learning model, the output (e.g., a user-specific price) in connection with the user. As described above, the second machine learning model may be trained to determine the output with a bias that is based on the probability of the user obtaining reparations. The output with the bias may be different from a non-biased output of the second machine learning model based on the input (e.g., the non-biased output may be less accurate than the biased output). For example, if the probability determined by the first machine learning model satisfies a threshold, then the output of the second machine learning (e.g., a user-specific price) may be biased (e.g., to a lower user-specific price than would have otherwise been output without biasing).

In some other implementations, the decision system may determine, using the first machine learning model, the output in connection with the user. That is, the decision system may determine the output without any biasing of the output. For example, the output of the first machine learning model may be a user-specific price that has not been biased. In some implementations, the decision system may determine, using the second machine learning model, an adjusted output (e.g., an adjustment to the output) in connection with the user. For example, the output of the second machine learning model may be a lower user-specific price than the user-specific price output by the first machine learning model. The second machine learning model may be trained to determine the adjusted output by biasing the original output based on the probability of the user obtaining reparations if the original output were to be erroneous. For example, a degree by which the adjusted output biases the output may increase with the probability of the user obtaining reparations, as described herein. The probability of the user obtaining reparations may be based on the data indicating the reparations and/or the complaints. That is, the second machine learning model may be trained to determine the adjusted output based on the data. In a similar manner as described above, the second machine learning model may be trained to determine the adjusted output further based on a use case associated with the first machine learning model. In other words, the probability of the user obtaining reparations may be further based on the use case associated with the first machine learning model.

The output may indicate a decision (e.g., an approval or a rejection) for the user's application for services. Thus, for example, if the probability of the user obtaining reparations is high (e.g., above a threshold), then the decision may be biased to be an approval of the application, even if the decision would have been a rejection of the application if the probability of the user obtaining reparations were low. In other examples, the output may indicate a recommendation of an action based on facial recognition, a recommendation of an item for the user to purchase, may indicate a user-specific price for goods or services, may indicate traveling directions for the user, or the like. In the example of the user-specific price, if the probability of the user obtaining reparations is high (e.g., above a threshold), then the price may be biased to a lower price based on the probability of the user obtaining reparations. In this way, the decision system may avoid reaching an erroneous decision in a case where characteristics of the user, or a lack of information about the user, would lead another AI system to an erroneous automated decision.

As shown in FIG. 1C, and by reference number 125, the decision system may transmit, and the user device may receive, information based on the output or the adjusted output. For example, the information may indicate the output/adjusted output, may indicate a decision based on the output/adjusted output, may indicate a recommendation based on the output/adjusted output, or the like. For example, the information may indicate, based on the output, an approval or a rejection of the user's application for services. As another example, the information may indicate a recommendation of an item for the user to purchase, may indicate a user-specific price for goods or services, may indicate traveling directions for the user, or the like.

In some implementations, the decision system may perform an action based on the output/adjusted output. For example, if the output indicates an approval of the user's application for services, the decision system may create or cause creation of an account for the user, generate or cause generation of documents relating to the services, perform or cause performance of the services, or the like. As another example, if the output indicates positive facial recognition of the user, the decision system may grant or cause granting of access to an account, grant or cause granting of access to a secured area, obtain or cause obtaining of records, or the like.

In some implementations, the decision system may determine an evaluation relating to the user based on the probability of the user obtaining reparations and/or the data indicating the reparations and/or complaints. For example, using a machine learning model (e.g., one or more of the machine learning models described above, or a different machine learning model) the decision system may determine the evaluation based on the data indicating the reparations and/or complaints. In some implementations, the evaluation may indicate a recommendation of whether a third party should conduct business with the user, enter into a relationship (e.g., a business relationship) with the user, enter into a contract with the user, or the like. For example, if the user has a significant history of obtaining reparations and/or is associated with a high probability of obtaining reparations, the recommendation may be that the third party should not conduct business with the user, enter into a relationship with the user, enter into a contract with the user, or the like. As an example, if the user is associated with an amount of historical reparations and/or a probability of obtaining reparations above a threshold, then the recommendation may be a first recommendation, and if the user is associated with an amount of historical reparations and/or a probability of obtaining reparations below a threshold, then the recommendation may be a second recommendation.

By biasing the output of the machine learning model(s), the decision system may improve the accuracy of the output, which may have otherwise been inaccurate due to a lack of information about the user and/or due to the user being associated with characteristics that are likely to lead to a mischaracterization of the user. Accordingly, the decision system may efficiently allocate and utilize computing resources that may have otherwise been expended to reach an erroneous output and/or to perform an automated action based on the erroneous output. Moreover, the decision system may conserve, or enable another device to conserve, computing resources that may have otherwise been expended in connection with receiving a complaint of an erroneous AI decision, investigating the erroneous AI decision, performing remedial actions for the erroneous AI decision, or the like. In addition, computing resources that may have otherwise been used attempting to understand or reverse engineer the logic used by AI in reaching an erroneous decision may be conserved.

As indicated above, FIGS. 1A-1C are provided as an example. Other examples may differ from what is described with regard to FIGS. 1A-1C.

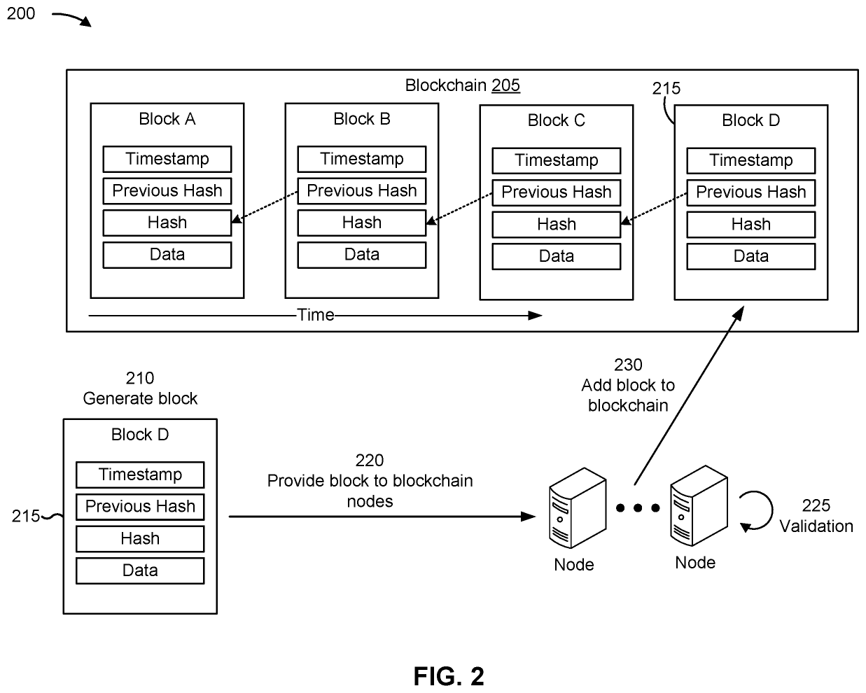

FIG. 2 is a diagram illustrating an example 200 of a blockchain and use thereof. As shown in FIG. 2, some operations of example 200 may be performed by multiple blockchain nodes. The blockchain nodes may form a blockchain network, and a blockchain 205 may be distributed among the blockchain nodes of the blockchain network. Blockchain 205 may be a distributed ledger, or database, that maintains a list of records, called blocks, that may be linked together to form a chain.

As shown by reference number 210, a procedure for adding to blockchain 205 may begin with generating a block 215. Block 215 may be generated in response to receiving a request (e.g., from the user device 410 or the decision system 420, described herein, or another device) to add information, called a transaction, to blockchain 205. In some implementations, block 215 may be generated by a blockchain node.

As shown, each block of blockchain 205, including generated block 215, indicates a timestamp, a previous hash, a hash, and data, among other examples. For block 215, the data may include the transaction that was requested to be added. For example, the transaction may indicate complaint information or judgment information, as described herein. The transaction may be grouped, in block 215, with one or more other transactions that are awaiting publication to blockchain 205. The timestamp, the previous hash, and the hash may define a header of a block. The hash of a block may be a hash representation (e.g., using one or more hashing methods) of the block's data, and the previous hash may be the hash value in the previous block's header. For example, the previous hash in the header of Block B may be the hash value in the header of Block A, and so forth. Thus, the blocks may be chained together by each block referencing the hash value of the previous block. In this way, an altered block may be easily detected and rejected from blockchain 205.

As shown by reference number 220, generated block 215 may be provided (e.g., broadcast) to all blockchain nodes in the blockchain network. As shown by reference number 225, before block 215 is added to blockchain 205, other blockchain nodes may agree that block 215 is valid. That is, the blockchain nodes may reach a consensus on the validity of block 215. To validate block 215, the blockchain nodes may utilize one or more consensus techniques, which may utilize a proof of work (PoW) algorithm, a proof of stake (POS) algorithm, a delegated proof of stake (DPoS) algorithm, and/or a practical Byzantine fault tolerance (PBFT) algorithm, among other examples. As shown by reference number 230, once validated, the blockchain nodes may add block 215 to their respective copies of blockchain 205.

As indicated above, FIG. 2 is provided as an example. Other examples may differ from what is described in connection with FIG. 2.

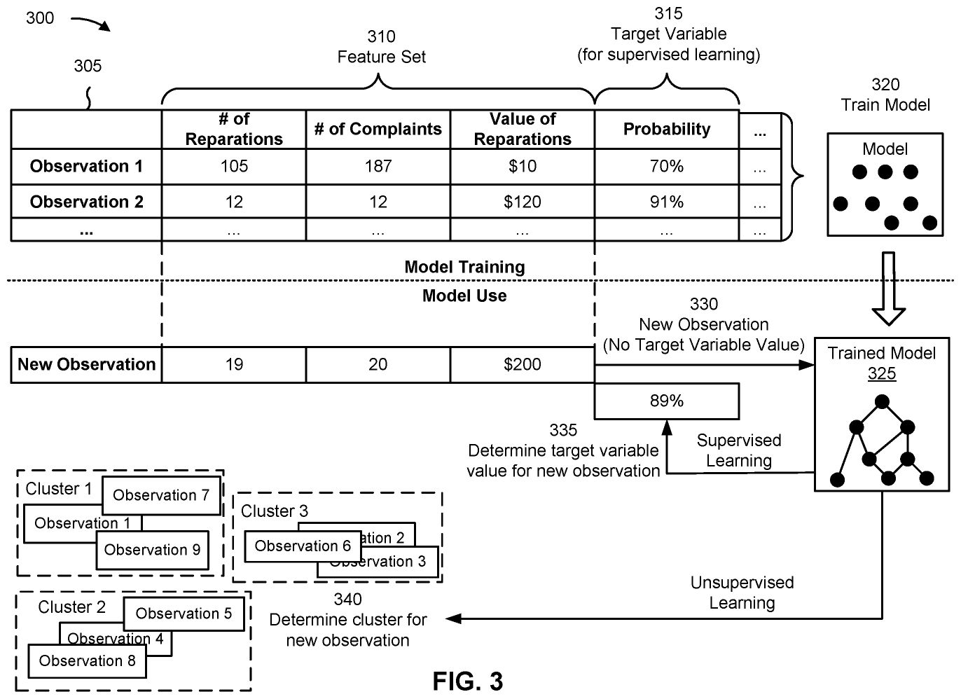

FIG. 3 is a diagram illustrating an example 300 of training and using a machine learning model in connection with biasing machine learning model outputs. The machine learning model training and usage described herein may be performed using a machine learning system. The machine learning system may include or may be included in a computing device, a server, a cloud computing environment, or the like, such as decision system 420 described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from decision system 420 and/or one or more blockchain nodes 430, as described elsewhere herein.

As shown by reference number 310, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from decision system 420 and/or one or more blockchain nodes 430. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of number of reparations issued to a user, a second feature of number of complaints registered by the user, a third feature of value of reparations issued to the user, and so on. As shown, for a first observation, the first feature may have a value of 105, the second feature may have a value of 187, the third feature may have a value of $10, and so on. These features and feature values are provided as examples, and may differ in other examples. For example, the feature set may include one or more of the following features: number of reparations issued to a user, number of complaints registered by the user, value of reparations issued to the user, average value of reparations issued to the user, minimum value of reparations issued to the user, maximum value of reparations issued to the user, modal value of reparations issued to the user, frequency at which reparations are issued to the user, frequency at which complaints are registered by the user, elapsed time since a most recent reparation was issued to the user, elapsed time since a most recent complaint was registered by the user, use cases associated with reparations issued to the user, use cases associated with complaints registered by the user, entities that issued reparations to the user, and/or entities associated with complaints registered by the user, among other examples.

As shown by reference number 315, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is probability of the user obtaining reparations, which has a value of 70% for the first observation.

The feature set and target variable described above are provided as examples, and other examples may differ from what is described above. For example, for a target variable of a decision whether to approve an application for services of a user, the feature set may include probability of the user obtaining reparations, age of the user, residence location of the user, employment status of the user, occupation of the user, annual income of the user, credit score of the user, number of credit accounts held by the user, total amount of credit available to the user, and/or amount of debt of the user, among other examples. As another example, for a target variable of a user-specific price for an item, the feature set may include probability of the user obtaining reparations, number of previous transactions of the user, total amount paid by the user in previous transactions, average amount paid by the user in previous transactions, number of times that the user has viewed the item, and/or frequency at which the user views the item, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, using a neural network algorithm, the machine learning system may train a machine learning model to output (e.g., at an output layer) a probability of a user obtaining reparations based on an input (e.g., at an input layer) of data (e.g., from a blockchain) indicating previous reparations or complaints associated with the user, as described elsewhere herein. In particular, the machine learning system, using the neural network algorithm, may train the machine learning model, using the set of observations from the training data, to derive weights for one or more nodes in the input layer, in the output layer, and/or in one or more hidden layers (e.g., between the input layer and the output layer). Nodes in the input layer may represent features of a feature set of the machine learning model, such as a first node representing number of reparations, a second node representing number of complaints, a third node representing value of reparations, and so forth. One or more nodes in the output layer may represent output(s) of the machine learning model, such as a node indicating a probability of a user obtaining reparations. The weights learned by the machine learning model facilitate transformation of the input of the machine learning model to the output of the machine learning model. After training, the machine learning system may store the machine learning model as a trained machine learning model 325 to be used to analyze new observations.

As an example, the machine learning system may obtain training data for the set of observations based on historical judgment information and/or complaint information, as described herein. The historical judgment information and/or complaint information may be obtained from a blockchain, as described herein.

As shown by reference number 330, the machine learning system may apply the trained machine learning model 325 to a new observation, such as by receiving a new observation and inputting the new observation to the trained machine learning model 325. As shown, the new observation may include a first feature value of 19, a second feature value of 20, a third feature value of $200, and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of 89% for the target variable of probability of a user obtaining reparations for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to bias a decision in favor of the user and/or a recommendation to avoid entering into a relationship with the user.

As another example, if the machine learning system were to predict a value of 3% for the target variable of probability of the user obtaining reparations, then the machine learning system may provide a second (e.g., different) recommendation (e.g., a recommendation to refrain from biasing a decision in favor of the user and/or a recommendation to enter into a relationship with the user) and/or may perform or cause performance of a second (e.g., different) automated action.

In some implementations, the trained machine learning model 325 may classify (e.g., cluster) the new observation in a cluster, as shown by reference number 340. The observations within a cluster may have a threshold degree of similarity. As an example, the machine learning system may classify the new observation in a first cluster (e.g., high probability of reparations being obtained), a second cluster (e.g., medium probability of reparations being obtained), a third cluster (e.g., low probability of reparations being obtained), and so forth.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include subsequent complaint information indicating whether a user actually sought reparations and/or subsequent judgment information indicating whether a user actually was issued reparations.

In this way, the machine learning system may apply a rigorous and automated process to assess whether a user is likely to obtain reparations for an erroneous AI decision and/or to bias machine learning model outputs based on the likelihood. The machine learning system may enable recognition and/or identification of tens, hundreds, thousands, or millions of features and/or feature values for tens, hundreds, thousands, or millions of observations, thereby increasing accuracy and consistency and reducing delay associated with assessing whether a user is likely to obtain reparations for an erroneous AI decision and/or biasing machine learning model outputs based on the likelihood relative to requiring computing resources to be allocated for tens, hundreds, or thousands of operators to manually assess whether a user is likely to obtain reparations for an erroneous AI decision and/or to bias machine learning model outputs based on the likelihood using the features or feature values.

As indicated above, FIG. 3 is provided as an example. Other examples may differ from what is described in connection with FIG. 3.

FIG. 4 is a diagram of an example environment 400 in which systems and/or methods described herein may be implemented. As shown in FIG. 4, environment 400 may include a user device 410, a decision system 420, one or more blockchain nodes 430, and a network 440. Devices of environment 400 may interconnect via wired connections, wireless connections, or a combination of wired and wireless connections.

The user device 410 may include one or more devices capable of receiving, generating, storing, processing, and/or providing information associated with biasing machine learning model outputs, as described elsewhere herein. The user device 410 may include a communication device and/or a computing device. For example, the user device 410 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The decision system 420 may include one or more devices capable of receiving, generating, storing, processing, providing, and/or routing information associated with biasing machine learning model outputs, as described elsewhere herein. The decision system 420 may include a communication device and/or a computing device. For example, the decision system 420 may include a server, such as an application server, a client server, a web server, a database server, a host server, a proxy server, a virtual server (e.g., executing on computing hardware), or a server in a cloud computing system. In some implementations, the decision system 420 may include computing hardware used in a cloud computing environment.

The blockchain node 430 may include one or more devices capable of receiving, generating, storing, processing, providing, and/or routing information associated with a blockchain, as described elsewhere herein. The blockchain node 430 may include a communication device and/or a computing device. For example, the blockchain node 430 may include a server or a user device.

The network 440 may include one or more wired and/or wireless networks. For example, the network 440 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 440 may enable communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with biasing machine learning model outputs. Device 500 may correspond to user device 410, decision system 420, and/or blockchain node(s) 430. In some implementations, user device 410, decision system 420, and/or blockchain node(s) 430 may include one or more devices 500 and/or one or more components of device 500. As shown in FIG. 5, device 500 may include a bus 510, a processor 520, a memory 530, an input component 540, an output component 550, and a communication component 560.

Bus 510 may include one or more components that enable wired and/or wireless communication among the components of device 500. Bus 510 may couple together two or more components of FIG. 5, such as via operative coupling, communicative coupling, electronic coupling, and/or electric coupling. For example, bus 510 may include an electrical connection, a wire, a trace, a lead, and/or a wireless bus. Processor 520 may include a central processing unit, a graphics processing unit, a microprocessor, a controller, a microcontroller, a digital signal processor, a field-programmable gate array, an application-specific integrated circuit, and/or another type of processing component. Processor 520 may be implemented in hardware, firmware, or a combination of hardware and software. In some implementations, processor 520 may include one or more processors capable of being programmed to perform one or more operations or processes described elsewhere herein.

Memory 530 may include volatile and/or nonvolatile memory. For example, memory 530 may include random access memory (RAM), read only memory (ROM), a hard disk drive, and/or another type of memory (e.g., a flash memory, a magnetic memory, and/or an optical memory). Memory 530 may include internal memory (e.g., RAM, ROM, or a hard disk drive) and/or removable memory (e.g., removable via a universal serial bus connection). Memory 530 may be a non-transitory computer-readable medium. Memory 530 may store information, instructions, and/or software (e.g., one or more software applications) related to the operation of device 500. In some implementations, memory 530 may include one or more memories that are coupled (e.g., communicatively coupled) to one or more processors (e.g., processor 520), such as via bus 510. Communicative coupling between a processor 520 and a memory 530 may enable the processor 520 to read and/or process information stored in the memory 530 and/or to store information in the memory 530.

Input component 540 may enable device 500 to receive input, such as user input and/or sensed input. For example, input component 540 may include a touch screen, a keyboard, a keypad, a mouse, a button, a microphone, a switch, a sensor, a global positioning system sensor, an accelerometer, a gyroscope, and/or an actuator. Output component 550 may enable device 500 to provide output, such as via a display, a speaker, and/or a light-emitting diode. Communication component 560 may enable device 500 to communicate with other devices via a wired connection and/or a wireless connection. For example, communication component 560 may include a receiver, a transmitter, a transceiver, a modem, a network interface card, and/or an antenna.

Device 500 may perform one or more operations or processes described herein. For example, a non-transitory computer-readable medium (e.g., memory 530) may store a set of instructions (e.g., one or more instructions or code) for execution by processor 520. Processor 520 may execute the set of instructions to perform one or more operations or processes described herein. In some implementations, execution of the set of instructions, by one or more processors 520, may cause the one or more processors 520 and/or the device 500 to perform one or more operations or processes described herein. In some implementations, hardwired circuitry may be used instead of or in combination with the instructions to perform one or more operations or processes described herein. Additionally, or alternatively, processor 520 may be configured to perform one or more operations or processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

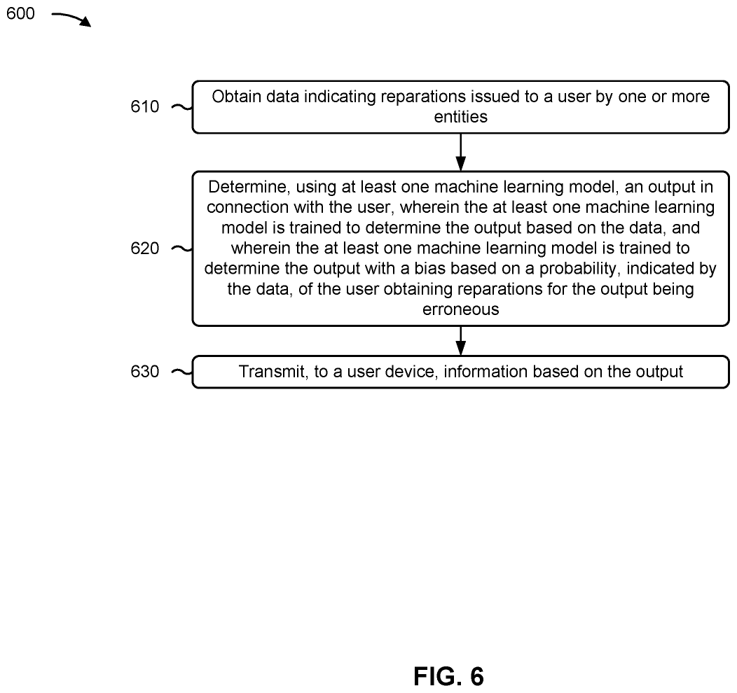

FIG. 6 is a flowchart of an example process 600 associated with biasing machine learning model outputs. In some implementations, one or more process blocks of FIG. 6 may be performed by the decision system 420. In some implementations, one or more process blocks of FIG. 6 may be performed by another device or a group of devices separate from or including the decision system 420, such as the user device 410 and/or one or more blockchain nodes 430. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include obtaining data indicating reparations issued to a user by one or more entities (block 610). For example, the decision system 420 (e.g., using processor 520, memory 530, and/or communication component 560) may obtain data indicating reparations issued to a user by one or more entities, as described above in connection with reference number 110 of FIG. 1A. As an example, the reparations may have been issued to the user as compensation for one or more erroneous AI decisions associated with the user, and records of the reparations may have been added to a blockchain. Accordingly, in some examples, the decision system may obtain the data from the blockchain.

As further shown in FIG. 6, process 600 may include determining, using at least one machine learning model, an output in connection with the user, where the at least one machine learning model is trained to determine the output based on the data, and where the at least one machine learning model is trained to determine the output with a bias based on a probability, indicated by the data, of the user obtaining reparations for the output being erroneous (block 620). For example, the decision system 420 (e.g., using processor 520 and/or memory 530) may determine, using at least one machine learning model, an output in connection with the user, as described above in connection with reference number 120 of FIG. 1B. In some implementations, the at least one machine learning model is trained to determine the output based on the data. In some implementations, the at least one machine learning model is trained to determine the output with a bias based on a probability, indicated by the data, of the user obtaining reparations for the output being erroneous. As an example, the output of the machine learning model(s) may be biased to be more favorable to the user (than the output otherwise would be if unbiased) if the probability of the user obtaining reparations is high.

As further shown in FIG. 6, process 600 may include transmitting, to a user device, information based on the output (block 630). For example, the decision system 420 (e.g., using processor 520, memory 530, and/or communication component 560) may transmit, to a user device, information based on the output, as described above in connection with reference number 125 of FIG. 1C. As an example, the information may indicate the output/adjusted output, may indicate a decision based on the output/adjusted output, may indicate a recommendation based on the output/adjusted output, or the like.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for biasing machine learning model outputs to improve accuracy, the system comprising:
one or more memories; and
one or more processors, communicatively coupled to the one or more memories, configured to:
determine, using a first machine learning model, a probability of a user obtaining reparations for an automated output, relating to an application for services made by the user, being erroneous,
wherein the first machine learning model is trained to determine the probability of the user obtaining reparations based on the data indicating reparations issued to the user by one or more entities;
provide information indicating the probability as an input to a second machine learning model;
determine, using the second machine learning model, an output in connection with the user relating to the application for services,
wherein the second machine learning model is trained to determine the output with a bias that is based on the probability of the user obtaining reparations, and
wherein the output with the bias is different from a non-biased output of the second machine learning model based on the input; and
generate one or more documents relating to the application for services based on the output of the second machine learning model.

2. The system of claim 1, wherein the data is in a blockchain.

3. The system of claim 1, wherein the data further indicates one or more complaints made by the user indicating that one or more automated outputs are erroneous.

4. The system of claim 1, wherein the output is biased in favor of the user if the probability of the user obtaining reparations is a first probability, and
wherein the output is unbiased if the probability of the user obtaining reparations is a second probability.

5. The system of claim 1, wherein a degree by which the output is biased increases with the probability of the user obtaining reparations.

6. The system of claim 1, wherein the output with the bias indicates an approval of the application for services, and the non-biased output is a rejection of the application for services.

7. The system of claim 1, wherein the one or more processors are further configured to:
identify that the second machine learning model is to be used to determine the output in connection with the user,
wherein the one or more processors, to determine the probability of the user obtaining reparations, are configured to:
determine the probability of the user obtaining reparations based on identifying that the second machine learning model is to be used to determine the output in connection with the user.

8. The system of claim 1, wherein the first machine learning model is trained to determine the probability of the user obtaining reparations further based on a use case associated with the second machine learning model.

9. A method of biasing machine learning model outputs, comprising:
obtaining, by a device, data indicating reparations issued to a user by one or more entities;
determining, by the device and using at least one machine learning model, an output in connection with the user,
wherein the at least one machine learning model is trained to determine the output based on the data, and
wherein the at least one machine learning model is trained to determine the output with a bias based on a probability, indicated by the data, of the user obtaining reparations for the output being erroneous; and
transmitting, by the device and to a user device, information based on the output.

10. The method of claim 9, wherein the at least one machine learning model comprises a first machine learning model trained to determine the probability of the user obtaining reparations based on the data, and a second machine learning model trained to determine the output based on the probability.

11. The method of claim 9, wherein the at least one machine learning model comprises a first machine learning model trained to determine the output, and a second machine learning model trained to determine an adjustment to the output based on the probability of the user obtaining reparations.

12. The method of claim 9, wherein the data is in a blockchain.

13. The method of claim 9, wherein the output indicates a decision for an application for services.

14. The method of claim 9, wherein the output is biased in favor of the user if the probability of the user obtaining reparations is a first probability, and
wherein the output is unbiased if the probability of the user obtaining reparations is a second probability.

15. The method of claim 9, wherein the at least one machine learning model is trained to determine the output further based on a use case associated with the at least one machine learning model.

16. A non-transitory computer-readable medium storing a set of instructions for biasing machine learning model outputs, the set of instructions comprising:
one or more instructions that, when executed by one or more processors of a device, cause the device to:
obtain data indicating reparations issued to a user by one or more entities;
determine, using a first machine learning model, an output in connection with the user;
determine, using a second machine learning model, an adjusted output in connection with the user,
wherein the second machine learning model is trained to determine the adjusted output by biasing the output based on a probability of the user obtaining reparations for the output being erroneous, and
wherein the probability of the user obtaining reparations is based on the data; and
transmit, to a user device, information based on the adjusted output.

17. The non-transitory computer-readable medium of claim 16, wherein the data is in a blockchain.

18. The non-transitory computer-readable medium of claim 16, wherein the probability of the user obtaining reparations is further based on a use case associated with the first machine learning model.

19. The non-transitory computer-readable medium of claim 16, wherein a degree by which the adjusted output biases the output increases with the probability of the user obtaining reparations.

20. The non-transitory computer-readable medium of claim 16, wherein the data further indicates one or more complaints made by the user indicating that one or more automated outputs are erroneous.
